(19) United States
(12) Patent Application Publication
(10) Pub. No.: US 2008/0295593 A1
(43) Pub. Date: Dec. 4, 2008

(54) FUEL SUPPLY SYSTEMS

(75) Inventor: Takashi Yokoo, Nagoya-shi (JP)

Correspondence Address: DENNISON, SCHULTZ & MACDONALD, 1727 KING STREET, SUITE 105, ALEXANDRIA, VA, 22314, US

(73) Assignee: Aisan Kogyo Kabushiki Kaisha, Obu-shi (JP)

(21) Appl. No.: 12/127,441

(22) Filed: May 27, 2008

(30) Foreign Application Priority Data
May 30, 2007 (JP) 2007-143318

(51) Int. Cl. G01F 23/30

(52) U.S. Cl. 73/305; 123/495

(57) ABSTRACT

A fuel supply system for supplying fuel from a fuel tank to an engine includes a fuel pump, a pressure regulator and a level sensor. The fuel pump pumps the fuel stored within the fuel tank. The pressure regulator regulates the pressure of the fuel before being supplied from the fuel pump to the engine and serves to return a surplus fuel into the fuel tank. The sensor detects the level of the fuel within the fuel tank and a surplus fuel is capable of being discharged to the sensor.

This application claims priority to Japanese patent application serial number 2007-143318, the contents of which are incorporated herein by reference.

### BACKGROUND OF THE INVENTION

1. Field of the Invention

The present invention relates to fuel supply systems for supplying fuel from a fuel tank to an engine of a motor vehicle, such as a four-wheeled motor vehicle and a two-wheeled motor vehicle.

2. Description of the Related Art

Japanese Laid-Open Patent Publication No. 2000-73900 teaches a known fuel supply system that includes a fuel pump, a pressure regulator and a level sensor. The fuel pump pumps fuel stored within a fuel tank to an internal combustion engine under pressure. The pressure regulator regulates the pressure of the fuel discharged from the fuel pump. The level sensor detects the level of the fuel within the fuel tank.

With this known fuel supply system, because the level sensor includes a slidably movable member, foreign particles including abraded powder of the movable member and impurities contained in the fuel may adhere or deposit onto the movable member. Therefore, if a large amount of foreign particles have adhered or deposited onto the movable member, there is a possibility that the level sensor cannot properly operate.

Therefore, there has been a need for fuel supply systems that can prevent or inhibit foreign particles from adhering onto a slidably movable member of a level sensor.

### SUMMARY OF THE INVENTION

One aspect according to the present invention includes a fuel supply system having a fuel pump and a fuel delivery path coupled to the fuel pump capable of transferring fuel to a level sensor, in particular a slide contact section of the level sensor. Therefore, the fuel can flush the slide contact section.

### BRIEF DESCRIPTION OF THE DRAWINGS

FIG. 1 is a view showing the construction of a fuel supply system according to a first embodiment of the present invention;

FIG. 2 is a view showing the construction of a sender gauge of the fuel supply system;

FIG. 3 is a schematic perspective view showing a slide contact section of the sender gauge;

FIG. 4 is a plan view of the slide contact section;

FIG. 5 is a vertical sectional view of a pressure regulator of the fuel supply system;

FIG. 6 is a view showing the construction of a fuel supply system according to a second embodiment of the present invention; and

FIG. 7 is a view showing the construction of a fuel supply system according to a fourth embodiment of the present invention.

### DETAILED DESCRIPTION OF THE INVENTION

Each of the additional features and teachings disclosed above and below may be utilized separately or in conjunction with other features and teachings to provide improved fuel supply systems. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a fuel supply system for supplying a fuel from a fuel tank to an engine includes a fuel pump, a pressure regulator and a level sensor. The fuel pump pumps the fuel stored within the fuel tank. The pressure regulator regulates the pressure of the fuel before being supplied from the fuel pump to the engine and serves to return a surplus fuel into the fuel tank. The sensor detects the level of the fuel within the fuel tank and includes a slide contact section. The surplus fuel is discharged toward the slide contact section.

Therefore, the flow of the surplus fuel can remove foreign particles that may have been adhered or deposited onto the slide contact section. As a result, it is possible to prevent or minimize potential malfunction or improper operation of the level sensor, which may be caused by the foreign particles.

The fuel supply system may further include a fuel filter disposed on at least one of a fuel suction side and a fuel discharge side of the fuel pump, so that a part of the fuel filtrated by the fuel filter is returned into the fuel tank as the surplus fuel. This can also lessen particulate build up by supplying a cleaner fuel to the level sensor.

The slide contact section may include a first member and a second member that slidably contact with each other. The first member can move to slide along the second member in response to change in the level of the fuel within the fuel tank. The first member may be an electrical contact and a second member may be a plurality of electrodes, so that the level sensor can output an electric signal corresponding to the position of the electrode with which the electric contact contacts. Removing the foreign particles by using the flow of the fuel can prevent or inhibit potential short-circuiting or improper contact condition of the electrical components of the level sensor.

The level sensor is disposed proximal to the fuel pump in a horizontal direction, and the pressure regulator may be disposed on upper side of the slide contact section of the level sensor. With this arrangement, the fuel pump, the level sensor and the pressure regulator can be assembled together, so that the fuel supply system may have a compact construction.

The fuel supply system may further include a surplus fuel discharge member coupled to the pressure regulator, so that the surplus fuel discharged from the pressure regulator is oriented toward the slide contact section. With this arrangement, it is possible to direct the fuel toward the slide contact section irrespective of the position of the pressure regulator.

In another embodiment, a fuel supply system for supplying a fuel from a fuel tank to an engine includes a fuel pump, a level sensor, a first fuel delivery path and a second fuel delivery path. The level sensor is disposed within the fuel tank. The first fuel delivery path is connected to the fuel pump, so that the fuel can be supplied from the fuel tank to the engine via the first fuel delivery path. The second fuel delivery path is branched off from the first delivery path to direct a part of the fuel toward the level sensor so as to flush the level sensor with the fuel. The second fuel delivery path may include a pressure regulator.

The fuel pump may be disposed within the fuel tank and the first fuel delivery path may extend from the fuel pump at a position within the inside of the fuel tank to the outside of the fuel tank. The fuel pump may be attached to a bottom wall or a top wall of the fuel tank.

Alternatively, the fuel pump may be disposed externally of the fuel tank, and the second fuel delivery path may extend from the outside of the fuel tank into the inside of the fuel tank.

The second fuel delivery path may have an end opening oriented vertically downward; and the slide contact section of the level sensor may be positioned below the end opening.

### FIRST EMBODIMENT

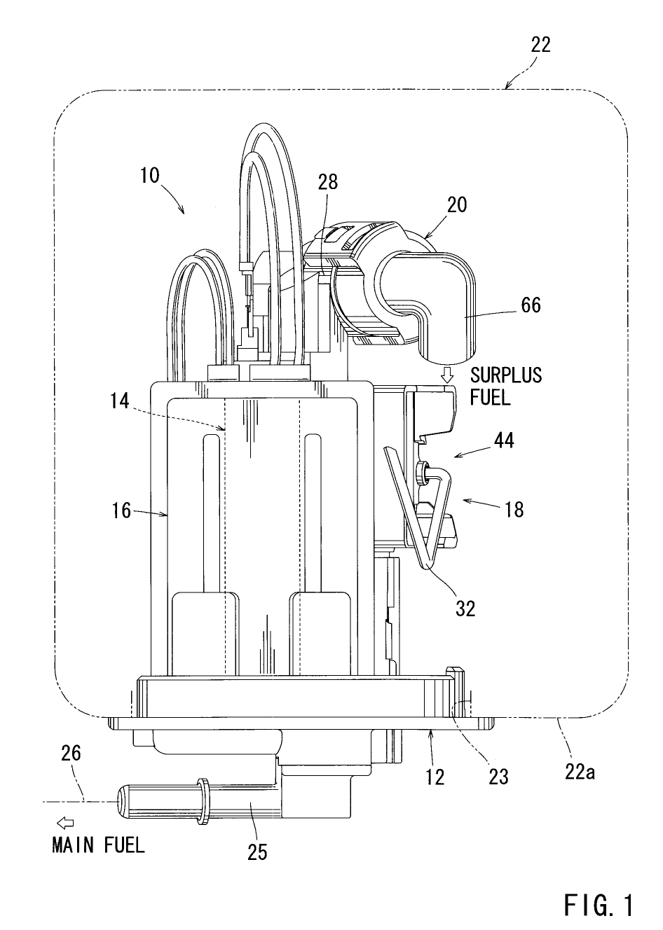

A first embodiment of the present invention will now be described with reference to FIGS. 1 to 5. FIG. 1 shows a fuel supply system 10 that can be used for a two-wheeled motor vehicle and a motor-assisted bicycle. As shown in FIG. 1, the fuel supply system 10 is configured to be mounted to a bottom plate 22a of a fuel tank 22 and includes a set plate 12, a fuel pump 14, a fuel filter 16, a sender gauge 18 and a pressure regulator 20 that are integrated as a module. An opening 23, such as a circular opening, is formed in the bottom plate 22a of the fuel tank 22.

The set plate 12 will be first described. The set plate 12 is attached to the bottom plate 22a of the fuel tank 22 from its lower side in such a manner that the set plate 12 sealingly closes the opening 23. A fuel discharge pipe 25 is formed integrally with the set plate 12 to extend from the lower side thereof in order to enable communication between the inside and the outside of the fuel tank 22. A fuel delivery pipeline 26 is connected to the fuel discharge pipe 25 for delivery of the fuel to an internal combustion engine, in particular to an injector(s) of the engine.

Next, the fuel pump 14 will be described. The fuel pump 14 is an electrically driven in-tank fuel pump and is mounted on the set plate 12 so as to be immersed into the fuel stored within the fuel tank 22 with the longitudinal axis of the fuel pump 14 extending substantially in a vertical direction. The fuel pump 14 has a pump section and a motor section disposed within a pump casing (not shown). The pump section is configured as a Westco pump and has an impeller(s) rotatably driven by the motor section upon starting the engine, so that the fuel within the fuel tank 22 is drawn into the pump casing from a fuel inlet port disposed at the bottom of the pump casing so as to be pressurized. The pressurized fuel is then discharged from a fuel outlet port disposed at the top of the pump casing. The fuel outlet port of the pump casing of the fuel pump 14 is connected to the fuel discharge pipe 25 via a piping member 28.

The fuel filter 16 will now be described. As shown in FIG. 1, the fuel filter 16 is disposed on the side of the inlet port of the fuel pump 14 and may be called as a suction filter. The fuel filter 16 serves to filtrate the fuel before the fuel is drawn into the pump casing of the fuel pump 14 via the inlet port. The fuel filter 16 is disposed on the set plate 12 and is attached to the front side (i.e., a front side in a direction perpendicular to the sheet of FIG. 1) of the fuel pump 14.

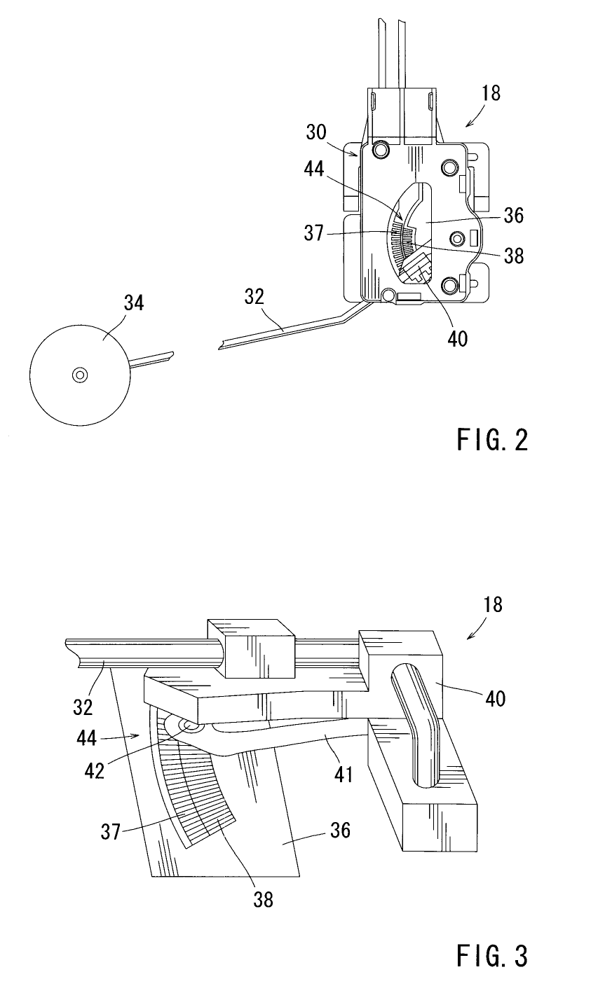

The sender gauge 18 will now be described. The sender gauge 18 is attached to the lateral side (right side as viewed in FIG. 1) of the fuel pump 14. The sender gauge 18 serves as a level gauge for detecting the level of the fuel remaining within the fuel tank 22 based on the electric resistance. As shown in FIG. 2, the sender gauge 18 includes a box-shaped gauge body 30, an arm 32 pivotally mounted to the gauge body 30, and a float member 34 attached to the free end of the arm 32. The float member 34 can float on the surface of the fuel within the fuel tank 22 (see FIG. 1). The gauge body 30 is fixedly mounted onto the set plate 12 (see FIG. 1). The gauge body 30 and the fuel pump 14 are electrically connected to each other via an electric line (not shown) that can be electrically connected to an external electric line via a connector mounted to the set plate 12.

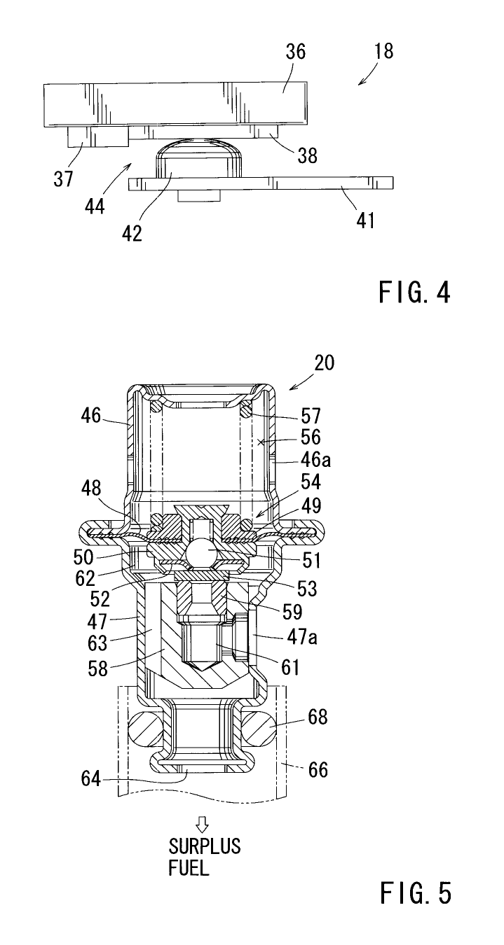

The gauge body 30 has a base plate 36 made of electrical insulation material, such as ceramic. As shown in FIGS. 3 and 4, a resistor 37 and a series of electrodes 38 are disposed on the outer surface of the base plate 36. The resistor 37 has an arc-shaped configuration about the pivotal axis of the arm 32. The electrodes 38 are disposed on the inner circumferential side of the resistor 37 and are configured as strips that are arranged substantially in parallel to each other in the circumferential direction of the resistor 37. As shown in FIG. 3, a slidably movable plate 41 having an electrical conductivity is coupled to the base end of the arm 32 via a holder 40 and extends parallel to the outer surface of the base plate 36. A button-like contact 42 is mounted to one end of the movable plate 41 for contacting with any one of the electrodes 42 (see FIG. 4). The arm 32 is made of electrical insulation material.

With the sender gauge 18 described above, as the level of the fuel within the fuel tank 22 varies, the float member 34 moves up or down, so that the arm 32 pivots about the pivotal axis. Then, the movable plate 41 moves with the arm 32, so that the contact 42 of the slide plate 41 moves along the series of the electrodes 38 of the base plate 36 so as to slidably contact with any one of the electrodes 38. Therefore, the level of the fuel or the remaining amount of the fuel within the fuel tank 22 can be detected based on the electric resistance of the resistor 37 at a position corresponding to the electrode 38 with which the contact 42 contacts. In this way, the electrodes 38 and the contact 42 constitute a slide contact section 44, and the sender gauge 18 serves as a level sensor.

The pressure regulator 20 will now be described. As shown in FIG. 1, the pressure regulator 20 is assembled within the piping member 28 at a position upward of the slide contact section 44 of the sender gauge 18 and serves to regulate the pressure of the fuel to be supplied from the fuel pump 14 to the engine. A cross sectional view of the pressure regulator 20 is shown in FIG. 5.

As shown in FIG. 5, the pressure regulator 20 has an upper casing 46 and a lower casing 47 that constitute a regulator housing. The outer circumferential edge of an annular diaphragm 48 made of rubber is clamped between the upper and lower casings 46 and 47. The inner circumferential edge of the diaphragm 48 is clamped between a spring seat 49 and a valve guide 50. A ball 51 is pressed against the valve guide 50 by an engaging plate 52. A plate-like valve member 53 is formed integrally with the ball 51. The diaphragm 48, the spring seat 49, the valve guide 50, the ball 51 and the valve member 53 can move together and constitute a movable assembly 54.

A spring chamber 56 is defined on the upper side of the diaphragm 48 within the upper casing 46. A spring 57 is disposed within the spring chamber 56 and biases the valve member 53 via the spring seat 49 in a direction toward a valve seat 59 mounted to a valve seat support 58 that will be explained below.

The valve seat support 58 is disposed within the lower casing 47 and has a first pressure chamber 61 formed therein. The valve seat 59 has a tubular configuration with a through bore that communicates with the first pressure chamber 61 and can be opened and closed by the valve member 53. Within the lower casing 47, a second pressure chamber 62 is defined between the diaphragm 48 and the valve seat support 58. A communication channel 63 is formed in the valve seat support 58 for communication between the second pressure chamber 62 and a surplus fuel discharge port 64 formed at the bottom of the lower casing 47.

With this arrangement, when the valve member 53 is seated against the valve seat 59, the communication between the first pressure chamber 61 and the second pressure chamber 62 is interrupted. When the valve member 53 is positioned away from the valve seat 59, the first pressure camber 61 and the second pressure chamber 62 communicate with each other.

The spring chamber 46 communicates with the interior of the fuel tank 22 via a communication hole 46a formed in the upper casing 46 and is maintained at substantially the atmospheric pressure that is applied to the movable assembly 54 in the seating direction of the valve member 53 against the valve seat 59. The first pressure chamber 61 communicates within the piping member 28 via a communication hole 47a formed in the lower casing 47. Therefore, the fuel discharged from the fuel pump 14 enters the first pressure chamber 61 and the pressure of the fuel is applied to the valve member 53 to force the movable assembly 54 upward as viewed in FIG. 5 to move the valve member 53 away from the valve seat 59.

One end of a surplus fuel discharge pipe 66 (see FIG. 1) is connected to the lower casing 47 and is in communication with the surplus fuel discharge port 64. The other end of the surplus fuel discharge pipe 66 is oriented downward to discharge the fuel toward the slide contact section 44 of the sender gauge 18, which is positioned below the surplus fuel discharge pipe 66. In this specification, the surplus fuel will be also referred to as “return fuel.”

Therefore, the surplus fuel or the return fuel from the pressure regulator 20 flows onto the slide contact section 44 of the sender gauge 18 via the surplus fuel discharge port 64 and the surplus fuel discharge pipe 66. An O-ring 68 seals between the lower end of the lower casing 47 and the surplus fuel discharge pipe 66 (see FIG. 5).

The valve member 53 can be seated against the valve seat 59 or positioned away from the valve seat 59 depending on the pressure of the fuel entering the first pressure chamber 61. Thus, if the force applied to the valve member 53 by the pressure of the fuel within the first pressure chamber 61 is smaller than the force applied to the movable assembly 54 to move the movable assembly 54 toward the valve seat 59, the valve member 53 is seated against the valve seat 59. The force applied to the movably assembly 54 to move it toward the valve seat 59 may include the force produced by the pressure within the spring chamber 56 and the force of the spring 57 (and the gravity force of the movable assembly 54 in the case of the arrangement of this embodiment). On the other hand, if the force applied to the valve member 53 by the pressure of the fuel within the first pressure chamber 61 is greater than the force applied to the movable assembly 54 to move it toward the valve seat 59, the valve member 53 is positioned away from the valve seat 59. The pressure within the spring chamber 56 may be constant because this pressure is equal to the pressure within the fuel tank 22.

Therefore, when the pressure within the first pressure chamber 61 or the pressure of the fuel discharged from the fuel pump 14 exceeds a predetermined value, the valve member 53 moves away from the valve seat 59, so that the fuel within the first pressure chamber 61 flows out of the through bore of the valve seat 59 to be discharged from the surplus fuel discharge port 64 via the second pressure chamber 62 and the communication channel 63. The space between the valve member 53 and the valve seat 59 may vary depending on the pressure of the fuel that flows out of the through bore of the valve seat 59, so that the amount of flow of the surplus fuel discharged from the discharge port 64 can be adjusted depending on the pressure of the fuel supplied from the fuel pump 14.

The operation of the fuel supply device 10 will now be described. As the engine is started, the fuel pump 14 is driven, so that the fuel within the fuel tank 22 is drawn into the fuel pump 14 via the fuel filter 16 that filtrate the fuel. The fuel is then discharged from the fuel pump 14 under pressure and is supplied to the engine via the piping member 28, the fuel discharge pipe 25 and the fuel delivery pipeline 26.

The sender gauge 18 detects the level or the remaining amount of the fuel within the fuel tank 22 based on the electric resistance of the resistor 37 that may vary depending on the position of one of the electrodes 38 with which the contact 42 of the movable plate 41 slidably contacts. The movable plate 41 moves to follow the movement of the arm 32 that pivots as the float member 34 moves with change of the level of the fuel. Although not shown in the drawings, the detection signal from the sender gauge 18 is inputted to a controller including an electronic control unit (ECU) via a connector portion of the set plate 12 and an external connector through lead wires. Based on the detection signal from the sender gauge, the controller calculates the remaining amount of the fuel within the fuel tank 22 and outputs a display signal to a display device, such as a warning indicator and a warning lamp.

The pressure of the fuel that is discharged from the fuel pump 14 and is supplied to the fuel discharge pipe 25 of the set plate 12 via the piping member 28 is regulated by the pressure regulator 20. The surplus fuel discharged from the surplus fuel discharge port 64 (see FIG. 5), as a result of regulation by the pressure regulator 20, is directed toward the slide contact section 33 of the sender gauge 18 as it is returned into the interior of the fuel tank 22. Therefore, foreign particles, such as abraded power produced at the slide contact section 33 and impurities contained in the fuel, which have been adhered or deposited onto the components of the slide contact section 44, may be flushed and removed.

Therefore, according to the fuel supply system 10 of this embodiment, it is possible to flush and remove the foreign particles that have been adhered or deposited onto the components of the slide contact section 44 of the sender gauge by using the surplus fuel discharged from the pressure regulator 20. Hence, it is possible to prevent or inhibit potential malfunction of the sender gauge 18, which may be caused, for example, by short-circuiting or contact failure of the slide contact section 44.

In addition, the surplus fuel returned from the pressure regulator 20 into the interior of the fuel tank 22 is a part of the fuel that has been filtrated by the fuel filter 16 before being drawn into the fuel pump 14. Therefore, a clean fuel is used for flushing and removing the foreign particles from the slide contact section 44.

Further, the sender gauge 18 is attached to the lateral side of the fuel pump 14, so that the sender gauge 18 is arranged side-by-side with the fuel pump 14, and the pressure regulator 20 is positioned on the upper side of the slide contact section 44 of the sender gauge 18 (see FIG. 1). Therefore, the fuel pump 14, the sender gauge 18 and the pressure regulator 20 can be put together such that the fuel supply system 10 has a compact construction.

Because the surplus fuel discharged from the surplus fuel discharge port 64 is directed toward the slide contact section 44 of the sender gauge 18 by the surplus fuel discharge pipe 66, the surplus fuel can be effectively discharged toward the slide contact section 44 even if the pressure regulator 20 is positioned away from the slide contact section 44.

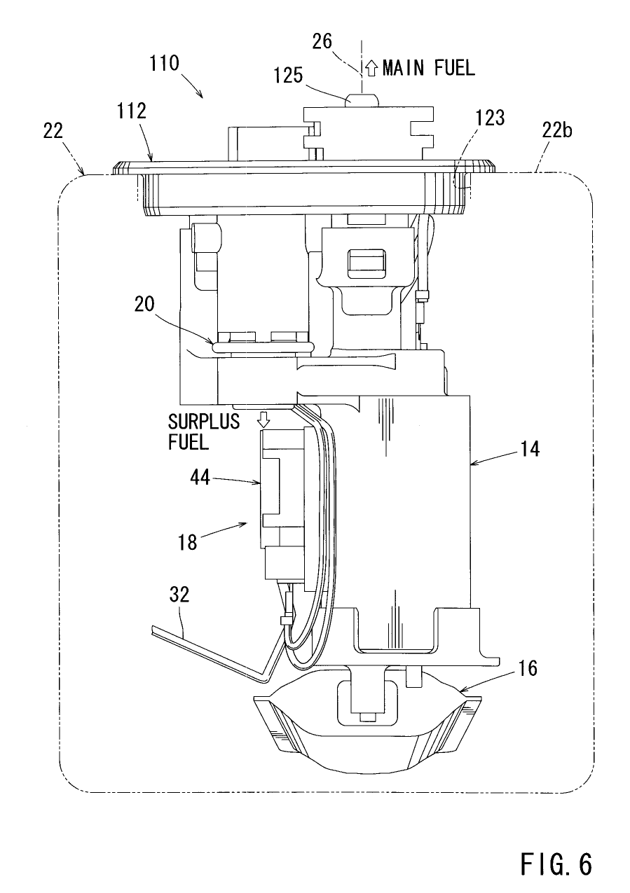

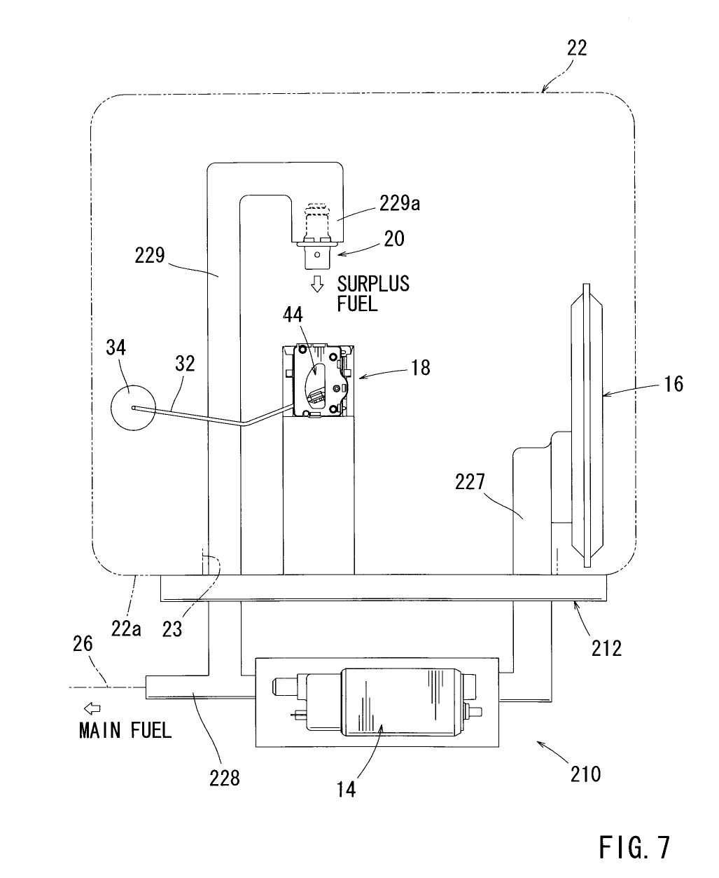

Second and third embodiments will now be described with reference to FIGS. 6 and 7, respectively. These embodiments are modifications of the first embodiment. Therefore, in FIGS. 6 and 7, like members are given the same reference numerals as the first embodiment and the description of these members will not be repeated.

### SECOND EMBODIMENT

As shown in FIG. 6, a fuel supply system 110 of the second embodiment is configured to be suspended from a top plate 22b of the fuel tank 22. The fuel supply system 110 has a set plate 112, the fuel pump 14, the fuel filter 16, the sender gauge 18 and the pressure regulator 20 that are integrated as a module. An opening 123, such as a circular opening, is formed in the top plate 22b of the fuel tank 22.

The set plate 112 is attached to the top plate 22b of the fuel tank 22 from its lower side in such a manner that the set plate 112 sealingly closes the opening 123. A fuel discharge pipe 125 is formed integrally with the set plate 112 to extend from the lower side thereof in order to enable communication between the inside and the outside of the fuel tank 22. A fuel delivery pipeline 26 is connected to the fuel discharge pipe 125 for delivery of the fuel to an internal combustion engine, in particular to an injector(s) of the engine.

The fuel pump 14 is mounted on the set plate 112 so as to be suspended from the set plate 112 and immersed into the fuel stored within the fuel tank 22. The fuel outlet port of the fuel pump 14 is connected to the fuel discharge pipe 125. The fuel filter 16 is positioned to contact with or adjacent to the bottom plate 22a.

The sender gauge 18 is attached to the lateral side (left side as viewed in FIG. 1) of the fuel pump 14. The pressure regulator 20 is attached to the lower side of the set plate 112 and is positioned above the sender gauge 18 such that the surplus fuel discharge port 64 (see FIG. 5) is oriented toward the slide contact section 44 of the sender gauge 18. Therefore, in this embodiment, the surplus fuel is directly discharged from the surplus fuel discharge port 64 toward the slide contact section 44 of the sender gauge 18. Thus, the surplus fuel discharge pipe 66 in the first embodiment is omitted.

Also with the second embodiment, the same operations and advantages as the first embodiment can be achieved.

### THIRD EMBODIMENT

As shown in FIG. 7, a fuel supply system 210 of the third embodiment is configured as a in-line system. Also in this embodiment, a set plate 212, the fuel pump 14, the fuel filter 16, the sender gauge 18 and the pressure regulator 20 that are integrated as a module.

The set plate 212 is attached to the bottom plate 22a of the fuel tank 22 from its lower side in such a manner that the set plate 212 sealingly closes the opening 23. The fuel pump 14 is positioned externally of the fuel tank 22 and is supported on the lower side the set plate 212 with the longitudinal axis of the fuel pump 14 extending in a substantially horizontal direction. The fuel filter 16 is connected to the fuel suction port of the fuel pump 14 via a suction-side piping member 227 that is supported by the set plate 212. A discharge-side piping member 228 is connected to the fuel discharge port of the fuel pump 14. The discharge-side piping member 228 is connected to the fuel delivery path 26 for supplying the fuel to the engine or the injector(s).

The sender gauge 18 is mounted on the upper side of the set plate 212 and is positioned such that its slide contact section 44 is located below an end portion 229a with an opening of a branch pipe 229 that is branched off from the discharge-side piping member 228. The branch pipe 229 extends upward from the discharge-side piping member 228 into the fuel tank 22 through the set plate 212. The upper portion of the branch pipe 229 is bent to have an inverted U-shape, so that the opening of the end portion 229a is oriented vertically downward. The pressure regulator 20 is assembled within the end portion 229a, so that the surplus fuel discharge port 64 (see FIG. 5) is oriented downward toward the slide contact section 44 of the sender gauge 18. Therefore, the surplus fuel produced as a result of regulation of pressure of the fuel by the pressure regulator 20 is directly discharged onto the slide contact section 44. Thus, also in this embodiment, the surplus fuel discharge pipe 66 (see FIG. 1) of the first embodiment is omitted.

### (Other Possible Modifications)

The present invention may not be limited to the above embodiments but may be modified further in various ways. For example, the fuel supply system of the present invention can be used for boats and ships and industrial machines and apparatus other than two or four wheeled motor vehicles and motor-assisted bicycles. It is not necessary to configure the fuel pump, the pressure regulator and the sender gauge as a module as long as the surplus fuel from the pressure regulator can be discharged onto the slide contact section of the sender gauge. Thus, at least one of the fuel pump, the pressure regulator and the sender gauge can be configured as a separate component from the others. Although the sender gauge in the above embodiment is of a slide-contact type, the sender gauge may be of a magnetic type. Further, although the fuel filter is disposed on the suction side of the fuel pump, it is possible to position the fuel filter on the discharge side of the fuel pump.

1. A fuel supply system for supplying fuel to an engine, comprising:
a fuel tank;
a fuel pump arranged and constructed to pump the fuel stored within the fuel tank;
a pressure regulator arranged and constructed to regulate the pressure of the fuel before being supplied to the engine and to return a surplus fuel into the fuel tank; and
a level sensor constructed to detect the level of the fuel within the fuel tank and comprising a slide contact section; wherein:
the surplus fuel is discharged toward the slide contact section.

2. The fuel supply system as in claim 1, further comprising a fuel filter disposed on at least one of a fuel suction side and a fuel discharge side of the fuel pump, so that a part of the fuel filtrated by the fuel filter is returned into the fuel tank as the surplus fuel.

3. The fuel supply system as in claim 1, wherein:
the slide contact section includes a first member and a second member that slidably contact with each other; and
the first member can move to slide along the second member in response to change in the level of the fuel within the fuel tank.

4. The fuel supply system as in claim 3, wherein:
the first member comprises an electrical contact;
the second member comprises a plurality of electrodes; and
the level sensor is configured to output an electric signal corresponding to the position of the electrode with which the electrical contact contacts.

5. The fuel supply system as in claim 1, wherein:
the level sensor is disposed proximal to the fuel pump in a horizontal direction; and
the pressure regulator is disposed on upper side of the slide contact section of the level sensor.

6. The fuel supply system as in claim 1, further comprising a surplus fuel discharge member coupled to the pressure regulator, so that the surplus fuel is discharged from the pressure regulator is oriented toward the slide contact section.

7. A fuel supply system for supplying a fuel to an engine, comprising:
a fuel tank;
a fuel pump coupled to the fuel tank;
a level sensor disposed within the fuel tank;
a first fuel delivery path connected to the fuel pump, so that the fuel can be supplied from the fuel tank to the engine via the first fuel delivery path;
a second fuel delivery path branched off from the first fuel delivery path and arranged and constructed to direct a part of the fuel toward the level sensor.

8. The fuel supply system as in claim 7, further comprising a pressure regulator disposed within the second fuel delivery path, wherein the part of the fuel is a surplus fuel discharged from the pressure regulator as a result of regulation of the pressure of the fuel to be supplied to the engine.

9. The fuel supply system as in claim 7, wherein the fuel pump is disposed within the fuel tank.

10. The fuel supply system as in claim 9, wherein the first fuel delivery path extends from the fuel pump at a position within the inside of the fuel tank to the outside of the fuel tank.

11. The fuel supply system as in claim 10, wherein the fuel pump is attached to a bottom wall of the fuel tank.

12. The fuel supply system as in claim 10, wherein the fuel pump is attached to a top wall of the fuel tank.

13. The fuel supply system as in claim 7, wherein the fuel pump is disposed externally of the fuel tank, and the second fuel delivery path extends from the outside of the fuel tank into the inside of the fuel tank.

14. The fuel supply system as in claim 7, wherein:
the level sensor comprises a slide contact section including a first member and a second member that can slidably contact with each other; and
the first member can move along the second member in response to change in the level of the fuel within the fuel tank; and
the second fuel delivery path is constructed to direct the part of the fuel toward the slide contact section.

15. The fuel supply system as in claim 14, wherein:
the second fuel delivery path has an end opening oriented vertically downward; and
the slide contact section of the level sensor is positioned below the end opening.
